(19) United States
(12) Patent Application Publication
(10) Pub. No.: US 2015/0224549 A1
(43) Pub. Date: Aug. 13, 2015

(54) METHOD AND MACHINE FOR CLEANING NEEDLES FOR INJECTING FLUIDS INTO MEAT PRODUCTS

(71) Applicant: METALQUIMIA, SA, Girona (ES)

(72) Inventor: Narcís Lagares Corominas, Besalu (ES)

(73) Assignee: METALQUIMIA, SA, Girona (ES)

(21) Appl. No.: 14/425,928

(22) PCT Filed: Mar. 1, 2013
(86) PCT No.: PCT/ES2013/000056

§ 371 Date: Mar. 4, 2015

(30) Foreign Application Priority Data
Sep. 5, 2012 (ES) P201230464

(51) Int. Cl. B08B 9/00

(52) U.S. Cl. CPC B08B 9/00

(57) ABSTRACT

The method consists of forcing a cleaning solution, such as caustic soda, through an inner passage of the needles (40), then injecting pressurized air into said needles, and afterwards flushing pressurized water through the inside of the needles. The machine comprises upper and lower compartments (2, 3) separated by a tray (6), and a tank (4) for the cleaning solution. The tray (6) supports the needles to be cleaned, such that a lower portion thereof is inside a number of containers (17) from which said needles (40) receive said cleaning solution driven by a pump (29), the pressurized air (23) and the washing water (25), through ducts (19, 21, 23, 25, 27) provided with valves (20, 24, 26, 28) in communication with the containers (17). The tray (6) collects the fluids coming out of the upper holes of the needles (40).

### TECHNICAL FIELD

The present invention relates to a method and a machine for cleaning needles for injecting fluids, especially brine, into meat products such as pork or similar, and optionally into fish products.

### STATE OF THE PRIOR ART

There are meat products that to be preserved have to be conveniently prepared, by introducing inside them suitable fluid ingredients, basically brine. The introduction of such fluids is preferably carried out mechanically for productivity reasons.

Document WO 2008/135610 and the according PCT/ES2008/000216 relates to a machine for injecting treatment fluids, especially brine, into meat products, which comprises one or more injection heads, each one of them integrating a plurality of hollow, parallel and retractable needles. This injection head is arranged and actuated so as to move upwards/downwards along a double vertical length, with respect to a supporting plane in a conveyor that conveys the meat pieces. Each needle has an inner longitudinal passage, an inlet opening in communication with said inner passage located in an upper portion of the needle and a plurality of outlet ports in communication with said inner passage located in a lower portion of the needle. The inlet opening of each needle is arranged in an injection chamber of pressurized fluid connected to means for feeding said fluid.

Said injection needles must periodically be cleaned for future reuse thereof, an operation that is usually carried out by detaching the needles from the injection head and leaving them soaking in a cleaning solution for a predetermined time period, which is usually relatively long, for example approximately 24 hours. This operation ends up being time-consuming and unproductive.

### DISCLOSURE OF THE INVENTION

The present invention proposes a method and a machine for cleaning needles for injecting fluids into meat products, of the needle variety provided with an inner longitudinal passage and a series of outlet ports in their lower portion and an inlet opening in their upper portion, in communication with said inner passage.

The method of the present invention comprises the insertion of one or more needles in one support base such that said outlet ports are inside an airtight vessel by way of a container and said upper inlet opening is inside an upper chamber, and thereafter carrying out the following steps:

a) feeding a pressurized cleaning solution, such as caustic soda, into said container so as to force said cleaning solution to penetrate through the outlet ports, pass through the inner duct and then exit through the upper inlet opening of said needle or of each needle, and from there pass to a tank for its eventual recovery, so that the cleaning solution cleans the inner duct and the holes of the needles;

b) feeding a pressurized gas, such as air, into said container so as to force said gas to penetrate through the outlet ports, pass through the inner duct and then exit through the upper inlet opening of said needle or of each needle, and from there outwards, in order to eject any cleaning solution that might remain inside the needles;

c) feeding a pressurized washing liquid, such as water, into said container so as to force said cleaning solution to penetrate through the outlet ports, pass through the inner duct and then exit through the upper inlet opening of said needle or of each needle, and from there outwards, so that the washing liquid washes the inner duct and the holes of the needles; and

d) feeding again a pressurized gas, such as air, into said container so as to force said gas to penetrate through the outlet ports, pass through the inner duct and then exit through the upper inlet opening of said needle or of each needle, and from there outwards, in order to eject any washing liquid that might remain inside the needles;

Should there be several containers, at least step a) shall be carried out sequentially in each one of the containers, that is to say, one container after the other. Optionally, steps b) and c) may also be carried out sequentially in one container after the other. If necessary, step a) will be carried out one or more times as need may be, for each needle container.

The machine of the present invention comprises one or more containers, each one of them closed at the top by a support base designed to hold at least one group of needles in a position in which said upper portion of the needles, where said inlet opening is located, remains outside said container and said lower portion of the needles, where said outlet ports are located, remains inside the container; drive means of the cleaning solution in communication with a tank of cleaning solution through an intake duct and with said container through a drive duct; an air supply duct, which communicates an air-supply source with the container; a washing-liquid supply duct, which communicates a source of washing liquid supply with the container; and means for opening and closing a fluid passage, interposed in said ducts.

Preferably, and especially when there is a plurality of containers, the drive duct, the air supply duct, and the washing-liquid supply duct are in communication with a collector, which is in turn in communication with each one of the containers via a number of respective ducts, provided with means for opening and closing a fluid passage, interposed therein.

Each support base comprises a plurality of holes suitable for the insertion of respective needles, and each one of said holes is provided with a sealing gasket. In addition, the container is fastened to the support base by sealing means, such that the only way out for the fluids injected under pressure into the container is along the inner passage of the needles that are being washed.

The machine may comprise, for example, a body in which it is possible to distinguish an upper compartment, a lower compartment and a side compartment, which includes said tank with the cleaning solution. A tray that constitutes a bottom of the upper compartment separates the upper and lower compartments. This tray collects the fluids that come out of the needles and is connected to a drain pipe. In addition, the tray supports the aforementioned support bases in a position in which the upper portion of the needles, where the inlet opening is located, is inside the upper compartment and said container is in the lower compartment. The drive means, said collector, said drive duct, said air supply duct, and said washing-liquid supply duct are housed in the lower compartment.

The upper compartment is provided with two covers: one outer cover for closing thereof, and an inner cover, which can be adjusted in height, designed to abut against the upper end of the needles supported on the support bases. The weight of this inner cover prevents the needles from sliding upwards due to the pressure of the liquids injected into the containers.

### BRIEF DESCRIPTION OF THE DRAWINGS

With the aim of facilitating understanding of the invention being proposed, by way of non-limiting example a set of sheets with drawings are attached hereto, in which:

FIG. 1 is a perspective view of a machine for cleaning needles used to inject fluids into meat products according to an embodiment of the present invention, when closed;

FIG. 2 is a perspective view of the machine shown in FIG. 1 with an outer and an inner cover, open so as to partially show the inside thereof; and

FIG. 3 is a schematic representation of the main components of the machine and their connections.

### DETAILED DESCRIPTION OF A PREFERRED EMBODIMENT OF THE INVENTION

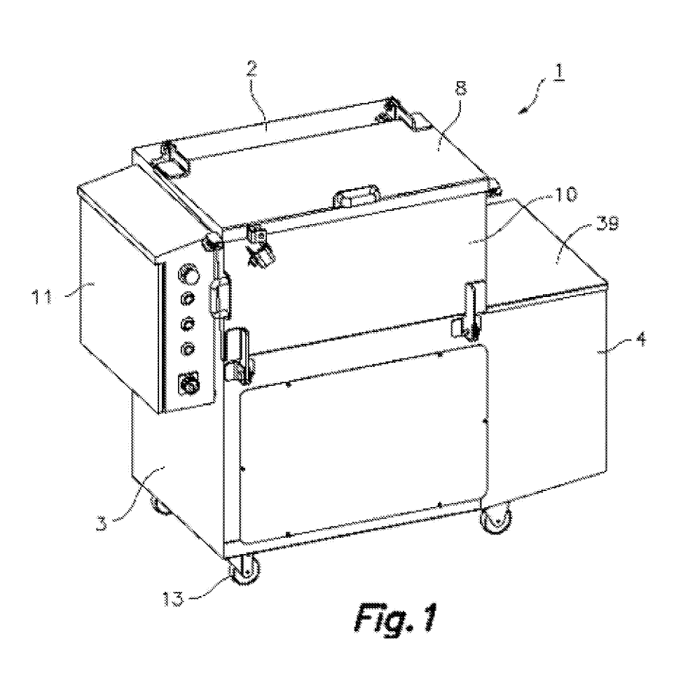

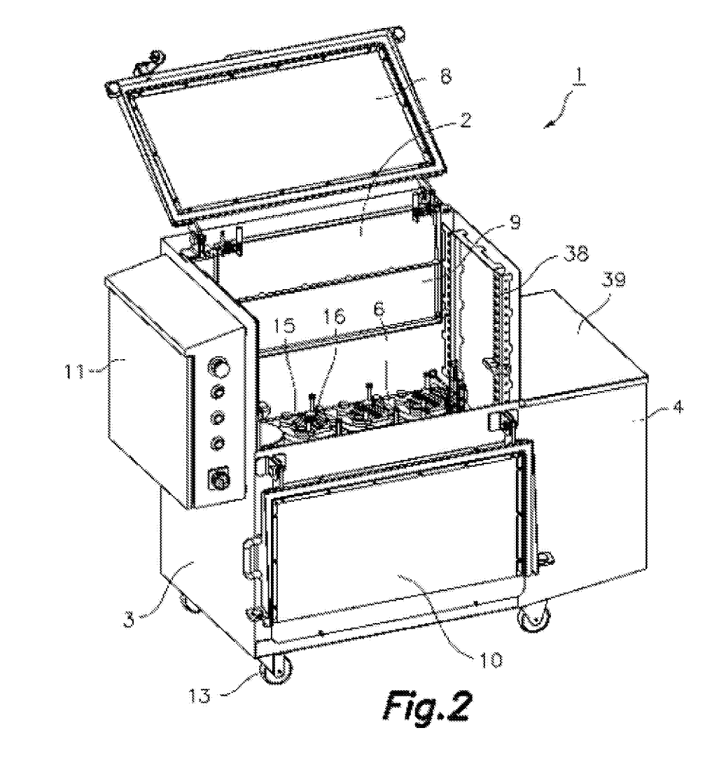

Firstly, in reference to FIGS. 1 and 2, the machine 1, according to an embodiment of the present invention, comprises a main body in which it is possible to distinguish: an upper compartment 2, a lower compartment 3 and a side compartment 4. The upper 2 and lower 3 compartments are separated by a tray 6 formed by a horizontal intermediate partition wall that constitutes the bottom of the upper compartment 2. The upper compartment 2 has a double cover: one upper outer cover 8 that provides access therein and one inner cover 9 the function of which is explained below.

In the embodiment shown in FIGS. 1 and 2, the upper compartment 2 has in addition a hinged front wall 10 that can be opened towards the front, which further facilitates access inside the upper compartment 2. In an alternative embodiment (not shown), instead of the hinged front wall, at least one portion of the front wall of the compartment 2 forms an integral part of the outer cover 8 and moves upwards together with the same when the outer cover 8 is opened to provide easy access to the upper compartment 2.

The lower compartment 3 houses various members, which will be listed below, necessary for the cleaning treatment of the needles, a cabinet 11 for the electrical control panel completes the machine, as well as lower wheels 13. The side compartment constitutes a tank 4.

The tray 6 forming the bottom of said upper compartment 2 of the machine body comprises one or more support bases 15 where needles (which are not represented in FIGS. 1 and 2) are inserted and supported. Each support base 15 is provided with a plurality of holes 16, each hole 16 with a sealing gasket (non-visible). On one side of said tray 6 there is a drain connected to a drain pipe 36, which communicates with the tank 4 located in the side compartment.

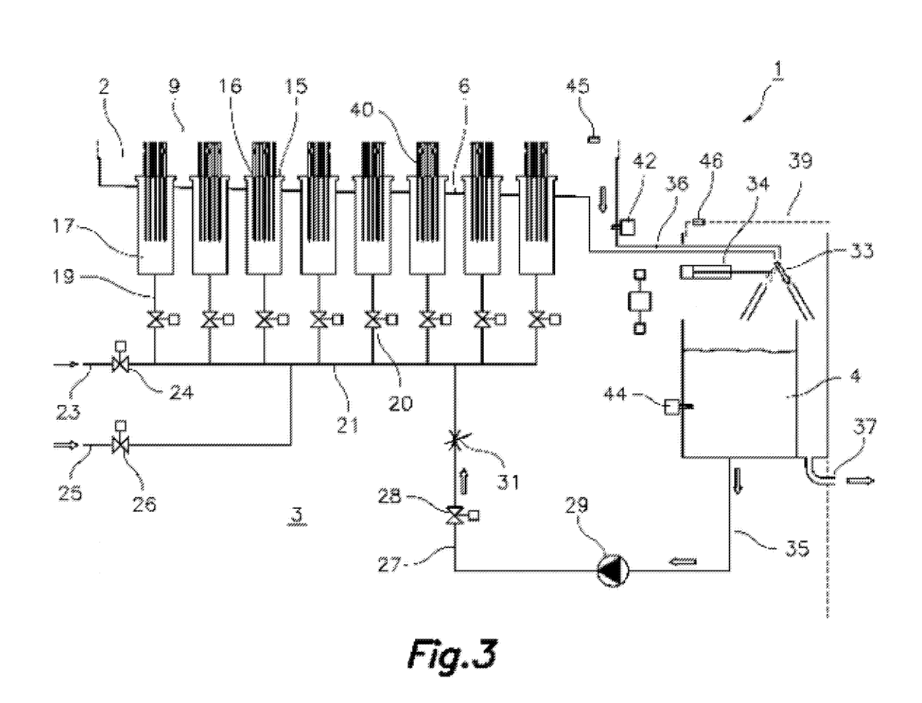

Now, with reference to FIG. 3, the lower compartment 3 contains a series of containers 17, each one of which is hermetically sealed at the top by one of said support bases 15. In the case illustrated, there is a plurality of containers 17 and these are connected in their lower portion to respective ducts 19, which in turn are connected in parallel to a collector 21, which in turn has a first connection with an air supply duct 23 that communicates with a source of pressurized air supply, a second connection with a washing-liquid supply duct 25, which communicates with a source of pressurized washing-liquid supply, and a third connection with a drive duct 27, which communicates with the drive outlet of a motor pump 29 used for driving the cleaning solution, the suction inlet of which is connected with a suction duct 35 that communicates with the aforementioned tank 4.

Each one of these ducts 19 connected to the containers 17 has a respective valve 20 interposed in it. Likewise, the air supply duct 23 and the water supply duct 25 have also respective valves 24 and 26 interposed in them. The drive duct 27 coming from the pump 29 has another valve 28 interposed in it, as well as, a flow regulating device 31. The opening and closing of said valves is actuated by actuation means and controlled automatically by the electrical control panel housed in said cabinet 11.

Said drain of the tray 6 forming the bottom of the upper compartment 2 communicates with the tank 4 through a deviation device 33, which is actuated by a fluid-dynamic actuator 34 that shifts the position of said deviator 33 such that the fluid coming from the drain pipe 36 is poured into the tank 4 or is deviated to an exit point 37 towards the outside the machine.

The needles 40 to be washed are of the hollow variety and have an inner longitudinal passage, a series of outlet ports (not shown) in their lower portion in communication with the inner passage and an inlet opening in their upper portion that is likewise in communication with the inner passage. In practice, when the needles 40 are inserted into the holes 16 of the support bases 15, said lower portion of each needle, where the outlet ports are located, is housed inside the respective container 17, whereas the upper portion of each needle, where the inlet opening is located, remains, as shown in FIG. 3, above the corresponding support base 15, i.e., outside the container 17 and inside the upper compartment 2.

During a cleaning operation, various groups of needles 40 to be cleaned, all of them identical in height, are inserted into the respective holes 16 of the support bases 15 associated with the the containers 17. Then, the inner cover 9 is lowered until it abuts against and rests on the upper end of all the needles 40, thus immobilizing them, and then the outer cover 8 is closed.

It must be mentioned that said inner cover 9 has hinge elements mounted on vertical guides 38 (FIG. 2), which have several anchoring points at different heights, so as to be able to adjust said inner cover 9 to needle 40 groups having different heights.

The method for cleaning needles for injecting fluids into meat products of the present invention, comprises firstly injecting, successively into each container 17 by means of the pump 29 and applying an alternating actuation to the valves 20, a cleaning solution, such as for instance a diluted caustic soda (NaOH) solution, coming from the tank 4. Thanks to the hermetical conditions of the containers 17, the caustic soda solution will penetrate through the outlet ports, pass through the inner passage and exit through the inlet opening of all the needles 40 arranged in each container 17, thus cleaning them.

The caustic soda solution coming out of the upper hole of the needles 40 lastly falls into the tray 6 that forms the bottom of the upper compartment 2, and is directed by the drain pipe 36 again towards the tank 4, from where it can be recycled once again towards the pump 29. Optionally, by shifting the position of the deviation device 33, the caustic soda solution coming from the drain pipe 36 can be ejected outside through the exit point 37.

This operation will be repeated, as the machine operator sees fit, one or more times for each one of the containers 17. Afterwards, each one of the remaining needle 40 containers will be treated accordingly in succession, opening the corresponding valve 20 and closing that of the other containers. The flow regulator 31 of the pump 29 shall be adequately adjusted, the valve 28 will be open and the other valves 24, 26 closed.

After having injected the caustic soda solution successively into all the containers 17 and having repeated the operation, when necessary, for one or more of them, the valve 28 of the pump 29 will be closed and the valve of the air supply duct 23 will be opened to successively inject into each one of the containers 17 pressurized air coming from a source of pressurized air supply, such as for example a compressor external to the machine. This is achieved by applying an alternating actuation to the valves 20.

The air injected into each container penetrates through the outlet ports, passes along the entire length of the inner passage and exits through the upper inlet opening of each needle 40, and then expands across all the upper compartment, passes through the drain pipe 36 and finally is deviated outwards by the deviator 33, which will be conveniently actuated so as to direct it towards the exit point 37.

Then, said valve 24 of the air supply duct 23 will be closed and the valve 26 of the pressurized water supply duct 25 will be opened, such that by applying an alternating actuation to the valves 20 the water will be injected successively into each container 17 and will penetrate accordingly through the outlet ports, pass along the entire length of the inner passage and exit through the upper inlet opening of each needle 40 in order to clean each one of them. This water, which acts as cleaning liquid, after exiting through the upper inlet opening of each needle, will fall into the tray 6 that forms the bottom of the upper compartment 2, pass through the drain pipe 36 and be deviated outwards by means of the deviator 33, to a spillway for example, through the exit point 37.

Finally, the valve 26 of the water supply duct 25 will be closed and the valve of the air supply duct 23 will be opened again to inject pressurized air coming from the source of pressurized air supply into each one of the containers 17.

The described electric and hydraulic circuits are supplemented with a return water sensor 42 located in the drain pipe 36, a safety-level sensor 44 located in the tank 4, a first electromagnetic safety device 45 for the inner cover 9, and a second electromagnetic safety device 46 for a tank cover 39, which closes the top of the tank 4.

A person skilled in the art may introduce changes and modifications in the described exemplary embodiments, without departing from the scope of the invention as defined in the accompanying claims.

1. A method for cleaning needles for injecting fluids into meat products, said needles comprising an inner longitudinal passage, a plurality of outlet ports in communication with said inner passage in its lower portion and an inlet opening in communication with the inner passage in its upper portion, the method comprising the step of:
inserting one or more of said needles into a support base such that said outlet ports of each needle are located inside an airtight container fastened to said support base and said inlet opening of each needle is located inside an upper chamber, and further comprising the subsequent steps of:
a) feeding a pressurized cleaning solution into said container, said cleaning solution thereby entering through the outlet ports, passing through the inside of the inner passage and exiting through said upper inlet opening of each needle;
b) feeding a pressurized gas into said container, said gas thereby entering through the outlet ports, passing through the inside of the inner passage and exiting through said upper inlet opening of each needle;
c) feeding a washing liquid into said container, said washing liquid thereby entering through the outlet ports, passing through the inside of the inner passage and exiting through said upper inlet opening of each needle; and
d) again feeding pressurized gas into said container, said gas thereby entering through the outlet ports, passing through the inside of the inner passage and exiting through said upper inlet opening of each needle.

2. The method according to claim 1, wherein said cleaning solution is caustic soda NaOH.

3. The method according to claim 1, wherein said gas is air.

4. The method according to claim 1, wherein said washing liquid is water.

5. The method according to claim 1, further comprising using several of said containers and carrying out at least step a) sequentially for every container one after another.

6. The method according to claim 5, wherein step a) is carried out one or more times for each container.

7. The method according to claim 1, further comprising collecting the cleaning solution that comes out through the inlet openings of the needles, in a tank of cleaning solution for recovery and/or recirculation thereof.

8. The method according to claim 1, comprises further comprising discharging, outside the machine, the gas coming out through the inlet openings of the needles.

9. (canceled)

10. A machine for cleaning needles for injecting fluids into meat products, each of said needles comprising an inner longitudinal passage, a plurality of outlet ports in communication with said inner passage in its lower portion and an inlet opening in communication with the inner passage at its upper portion, the machine comprising:
at least one airtight container that is closed at the top by a support base designed to hold at least one group of needles in a position in which said upper portion of the needles 404, where said inlet opening is located, remains outside said container and said lower portion of the needles, where said outlet ports are located, is inside the container,
drive means for driving the cleaning solution in communication with a tank of cleaning solution through an intake duct and with said container through a drive duct,
an air-supply duct, which communicates an air-supply source with the container,
a washing-liquid supply duct, which communicates a source of washing liquid supply with the container, and
means for opening and closing a fluid passage interposed in said ducts.

11. The machine for cleaning needles according to claim 10, wherein said drive duct, air supply duct, and washing-liquid supply duct are in communication with a collector, which in turn is in communication with a container through a duct provided with means for opening and closing a fluid passage interposed therein.

12. The machine for cleaning needles according to claim 11, further comprising a plurality of said containers, said collector being in communication with each one of the containers via the respective ducts provided with said means for opening and closing a fluid passage interposed therein.

13. The machine for cleaning needles according to claim 10, wherein said support base comprises a plurality of holes suitable for the insertion of respective needles, and each one of said holes is provided with a sealing gasket.

14. The machine for cleaning needles according to claim 10, further comprising a tray arranged so as to collect the fluids coming out of the inlet opening located in the upper portion of each needle.

15. The machine for cleaning needles according to claim 13, further comprising a body having an upper compartment, a lower compartment and a side compartment, which includes said cleaning solution tank, wherein said upper and lower compartments are separated by a tray that constitutes a bottom of the upper compartment, wherein said tray is connected to a drain pipe and supports said support bases in a position in which the upper portion of the needles, where the inlet opening is located, is inside the upper compartment and said container is in the lower compartment, and wherein said drive means, said collector, said drive duct, said air supply duct, and said washing-liquid supply duct are housed in the lower compartment.

16. The machine for cleaning needles according to claim 15, wherein the upper compartment is provided with an outer cover for closing the same, and an inner cover, which can be adjusted in height and designed to abut against the upper end of the needles supported on the support bases.

17. The machine for cleaning needles according to claim 16, wherein said inner cover, which can be adjusted in height, is mounted on vertical guides provided with several anchoring points at various heights.

18. The machine for cleaning needles according to claim 15, wherein said drain pipe ends in a deviation device actuated by a fluid-dynamic actuator capable of moving said deviator to selectively direct the fluid coming from the drain pipe towards the tank or towards an exit point that drains out of the machine.

19. The machine according to claim 11, wherein said means for opening and closing a fluid passage interposed in said ducts are valves actuated by automatic means.

20. The machine for cleaning needles according to claim 10 or 15, further comprising a safety-level sensor device in the cleaning solution tank.

21. (canceled)

22. The machine for cleaning needles according to claim 15, wherein the drain pipe is provided with a sensor device for detecting return fluid therein, the inner cover is provided with an electromagnetic safety device and the tank has a tank cover provided with an electromagnetic safety device.
